(19) United States
(12) Patent Application Publication
(10) Pub. No.: US 2007/0153149 A1
(43) Pub. Date: Jul. 5, 2007

(54) TFT SUBSTRATE, LIQUID CRYSTAL DISPLAY PANEL, AND METHODS FOR MANUFACTURING THE SAME

(75) Inventors: Tai Yuan CHEN, TAICHUNG CITY (TW); Shu Hui LIN, TAINAN COUNTY (TW); Hsiao Ping LIN, FONGYUAN CITY (TW)

Correspondence Address: LOWE HAUPTMAN BERNER, LLP, 1700 DIAGONAL ROAD, SUITE 300, ALEXANDRIA, VA, 22314, US

(73) Assignee: WINTEK, TAICHUNG (TW)

(21) Appl. No.: 11/464,041

(22) Filed: Aug. 11, 2006

(30) Foreign Application Priority Data
Jan. 2, 2006 (TW) 95100027

(51) Int. Cl. G02F 1/136

(52) U.S. Cl. 349/43

(57) ABSTRACT

A thin film transistor substrate includes a transparent substrate, a plurality of thin film transistors, a passivation insulating layer and a plurality of pixel electrodes. The thin film transistors are disposed on the transparent substrate and include a gate insulating film. The passivation insulating layer is disposed on the gate insulating film and covers the thin film transistors, wherein the passivation insulating layer is formed with a concave-convex surface, a plurality of contact holes and a plurality of light-transmissive regions, and the light-transmissive regions are located above the gate insulating film. The pixel electrodes are disposed on the concave-convex surface and the light-transmissive regions, wherein each pixel electrode is electrically connected to the thin film transistor via the contact hole.

### BACKGROUND OF THE INVENTION

1. Field of the Invention

The present invention generally relates to a transflective liquid crystal display device, and more particularly to a thin film transistor substrate including a passivation insulating layer, which is formed with a concave-convex surface, a plurality of contact holes and a plurality of light-transmissive regions.

2. Description of the Related Art

With the development of high-tech applications, video products, e.g. digital video or image device have become popular products at everyday existence. In the digital video or image device, a liquid crystal display device is an importance element for displaying the correlative information. A user can read the required information from the liquid crystal display device.

Referring to FIG. 1, U.S. Pat. No. 6,284,558 B1, entitled “Active Matrix Liquid Crystal Display Device And Method For Making The Same”, discloses a conventional liquid crystal display device 10 including a thin film transistor substrate 20, a color filter substrate 40 and a liquid crystal layer 12 located between the thin film transistor substrate 20 and the color filter substrate 40. The thin film transistor substrate 20 includes a gate electrode 22, a gate insulating film 24, an semiconductor layer 25, a source electrode 26, a drain electrode 28, a passivation layer 30 and a pixel electrode 32 formed on a glass substrate 34 in sequence. The passivation layer 30 includes an organic material film and an inorganic material film (e.g., SiNₓ). The passivation layer 30 is made of material with low permittivity to protect the semiconductor layer 25, the source electrode 26 and the drain electrode 28 and to separate the pixel electrode 32 from a scan line (not shown) or a data line (not shown) so as to reduce the capacitance between the pixel electrode 32 and the scan and the data lines. The color filter substrate 40 includes a color filter layer 42 and an opposing transparent electrode 44 formed on another glass substrate 46 in sequence.

Generally, a transmissive liquid crystal display (LCD) device has advantages of high contrast ratio and good color saturation. However, the transmissive LCD device may render low image contrast when ambient light is bright. In addition, its power consumption is high due to the need of a backlight source. On the other hand, a reflective LCD device uses ambient light, instead of backlight, for displaying images; therefore, its power consumption is relatively low. However, the image rendered by the reflective LCD device is less visible when ambient light is dark.

In order to overcome the above-mentioned disadvantages of the transmissive and reflective LCD devices, a transflective LCD device is developed. The transflective LCD device can use both the backlight and the ambient light, so that it can render a clear image even in dark surroundings and with low power consumption.

Referring to FIG. 2, Japan Patent Publication Number 2003-156766, entitled “Reflection Type Liquid Crystal Display Unit And Its Manufacturing Method”, discloses a conventional reflective liquid crystal display device 50 including a thin film transistor substrate 60, a color filter substrate 80 and a liquid crystal layer 52 located between the thin film transistor substrate 60 and the color filter substrate 80. The thin film transistor substrate 60 includes a plurality of pixel regions, wherein each pixel region includes a thin film transistor 62, an insulating layer 64 and a reflective electrode 66 formed on a transparent substrate 68 in sequence. The insulating layer 64 has a structure with concave-convex surface. The reflective electrode 66 is formed on the concave-convex surface of the insulating layer 64 and electrically connected to the thin film transistor 62. The insulating layer 64 is made of organic material or inorganic material, and is used to protect the thin film transistor 62. The color filter substrate 80 includes a color filter layer 82 and an opposing transparent electrode 84 formed on another transparent substrate 86 in sequence.

However, most embodiments of the above-mentioned Japan patent disclose that the concave-convex surface of the insulating layer can be only applied to the reflective liquid crystal display device. Although one of embodiments discloses the concave-convex surface of the insulating layer which is applied to the transflective liquid crystal display device, the one of embodiments and FIG. 13b thereof only disclose that the insulating layer is made of transparent and sensitive material and is formed with the concave-convex surface such that the whole pixel region is formed to be a transflective region. More detailed, the above-mentioned Japan patent fails to disclose that the insulating layer has a light-transmissive region such that the whole pixel region is divided into a transmissive region and a reflective region.

Accordingly, there exists a need for a thin film transistor substrate that can be applied to a transflective liquid crystal display device in order to solve the above-mentioned problems.

### SUMMARY OF THE INVENTION

It is an object of the present invention to provide a thin film transistor substrate including a passivation insulating layer which is formed with concave-convex surface, a plurality of contact holes and a plurality of light-transmissive regions, wherein the light-transmissive region is formed on the gate insulating film, whereby the light of the backlight source can pass through the light-transmissive region completely.

In order to achieve the foregoing object, the present invention provides a thin film transistor substrate including a transparent substrate, a plurality of thin film transistors, a passivation insulating layer and a plurality of pixel electrodes. The thin film transistors are disposed on the transparent substrate and include a gate insulating film. The passivation insulating layer is disposed on the gate insulating film and covers the thin film transistors, wherein the passivation insulating layer is formed with a concave-convex surface, a plurality of contact holes and a plurality of light-transmissive regions, and the light-transmissive regions are located above the gate insulating film. The pixel electrodes are disposed on the concave-convex surface and the light-transmissive regions, wherein each pixel electrode is electrically connected to the thin film transistor via the contact hole.

Specially, the passivation insulating layer of the present invention is formed with a concave-convex surface, a plurality of contact holes and a plurality of light-transmissive regions by a gray-scale photomask. The light-transmissive region is directly located on the gate insulating film, whereby the light of the backlight source can passes through the light-transmissive region completely. Compared with the prior art, the passivation insulating layer of the present invention has the light-transmissive region which can increase the light-transmissive rate of the backlight.

Furthermore, the thin film transistor of the present invention further includes a low electrode of storage capacitor, wherein the gate insulating film and the passivation insulating layer are located between the low electrode of storage capacitor and the pixel electrode so as to define a dielectric layer of storage capacitor. Determining the capacitance of storage capacitor of the present invention can be completed without additional photolithography process. Only the same original gray-scale photomask and photolithography process is required.

The foregoing, as well as additional objects, features and advantages of the invention will be more apparent from the following detailed description, which proceeds with reference to the accompanying drawings.

### BRIEF DESCRIPTION OF THE DRAWINGS

FIG. 1 is a sectional schematic view of a liquid crystal display device in the prior art.

FIG. 2 is a sectional schematic view of another liquid crystal display device in the prior art.

FIG. 3 is a sectional schematic view of a liquid crystal display device according to an embodiment of the present invention.

FIG. 4 is a sectional schematic view of a liquid crystal display device according to an alternative embodiment of the present invention.

FIG. 5 is a sectional schematic view of a liquid crystal display device according to another alternative embodiment of the present invention.

FIGS. 6 to 10 are sectional schematic views of a method for manufacturing a liquid crystal display device of the present invention.

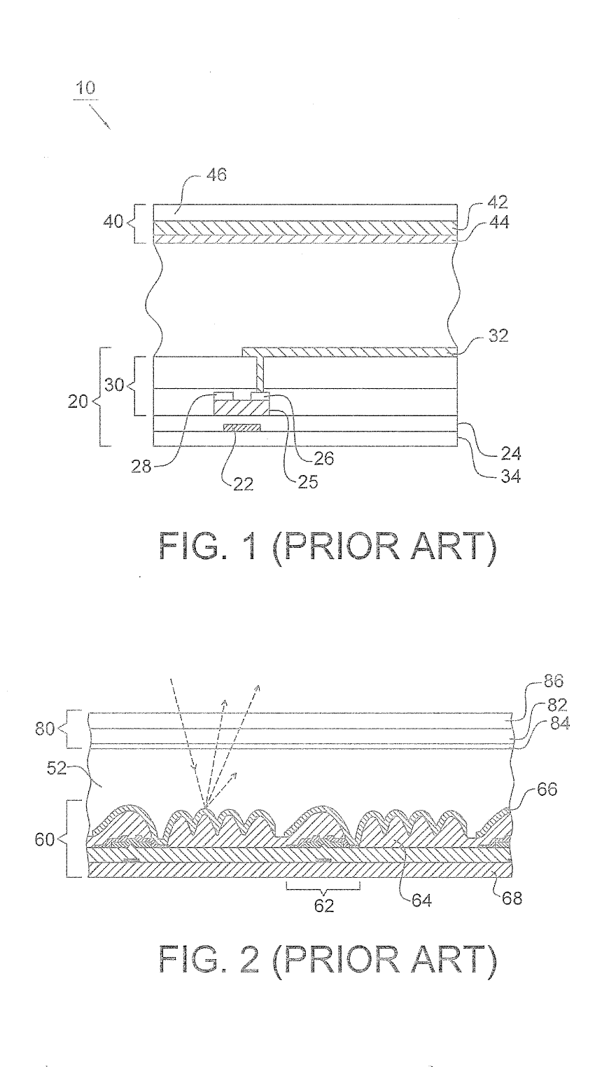

### DETAILED DESCRIPTION OF THE PREFERRED EMBODIMENT

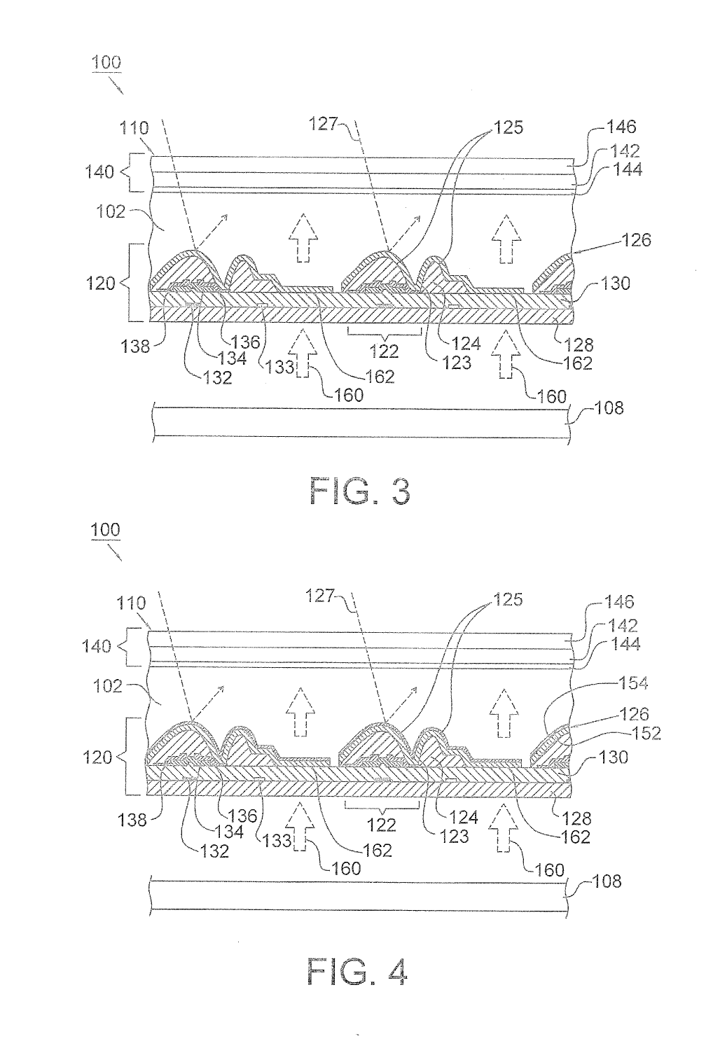

Referring to FIG. 3, it depicts a transflective liquid crystal display device 100 according to an embodiment of the present invention. The liquid crystal display device 100 includes a liquid crystal display panel 110 and a backlight source 108. The liquid crystal display panel 110 includes a thin film transistor substrate 120, an upper substrate 140 and a liquid crystal layer 102 located between the thin film transistor substrate 120 and the upper substrate 140. The thin film transistor substrate 120 includes a plurality of pixel regions, wherein each pixel region includes a thin film transistor 122, a passivation insulating layer 124 and a pixel electrode 126 formed on a transparent substrate 128 in sequence. The transparent substrate 128 generally includes a polarizing film (not shown) and a retardation film (not shown). The thin film transistor 122 generally includes a gate electrode 132, a gate insulating film 130, a semiconductor layer (e.g. a-Si layer) 134, a source electrode 138 and a drain electrode 136. The gate electrode 132 is disposed on the transparent substrate 128. The gate insulating film 130 is disposed on the transparent substrate 128 and covers the gate electrode 132. The semiconductor layer 134, the source electrode 138 and the drain electrode 136 are disposed on the gate insulating film 130. The gate insulating film 130 can be made of material of light transmittance.

The passivation insulating layer 124 is disposed on the gate insulating film 130 and covers the thin film transistor 122, wherein the passivation insulating layer 124 is formed with the structure of a concave-convex surface 125 and a plurality of contact holes 123 by a gray-scale photomask and a photolithography process. The passivation insulating layer 124 can be made of organic material or inorganic material, can protect the thin film transistor 122, and can separate the thin film transistor 122 from the pixel electrode 126.

Specially, the passivation insulating layer 124 of the present invention is further formed with a plurality of light-transmissive regions 162 by simultaneously the same gray-scale photomask and photolithography process. The light-transmissive region 162 is directly located on the gate insulating film 130, whereby the light of the backlight source 108 can pass through the light-transmissive region 162 completely. Generally, the pixel region can be divided into a transmissive region and a reflective region. Preferably, the ratio of the reflective region to the transmissive region is 1 to 4 for displaying an image well, but it is not used to limit the invention. Compared with the prior art, the passivation insulating layer 124 of the present invention is formed with the light-transmissive region 162 for increasing the light-transmissive rate of the backlight source 108.

The pixel electrode 126 is disposed on the concave-convex surface 125 and the light-transmissive region 162, and is electrically connected to the thin film transistor 122 via the contact hole 123. The reflective electrode 126, which is located on the concave-convex surface 125 of the passivation insulating layer 124, is in the shape of similar concave-convex surface 125 for unsymmetrically reflecting the ambient light 127, thereby increasing the uniformity of light. The pixel electrode 126 can be made of electrically conductive and transflective material, shown in FIG. 3. In other words, the pixel electrode 126 can be used to conduct electricity, partly reflect the light, and partly transmit the light.

Otherwise, referring to FIG. 4, it depicts a liquid crystal display device 100 according to an alternative embodiment of the present invention. The pixel electrode 126 can include a transparent electrode 152 and a transflective film 154. In other words, the transparent electrode 152 can be used to conduct electricity and transmit the light, can be disposed on the concave-convex surface 125 and the light-transmissive region 162, and can be electrically connected to the thin film transistor 122 via the contact hole 123. The transflective film 154 can be used to partly reflect the light and partly transmit the light, and can be disposed on the whole transparent electrode 152.

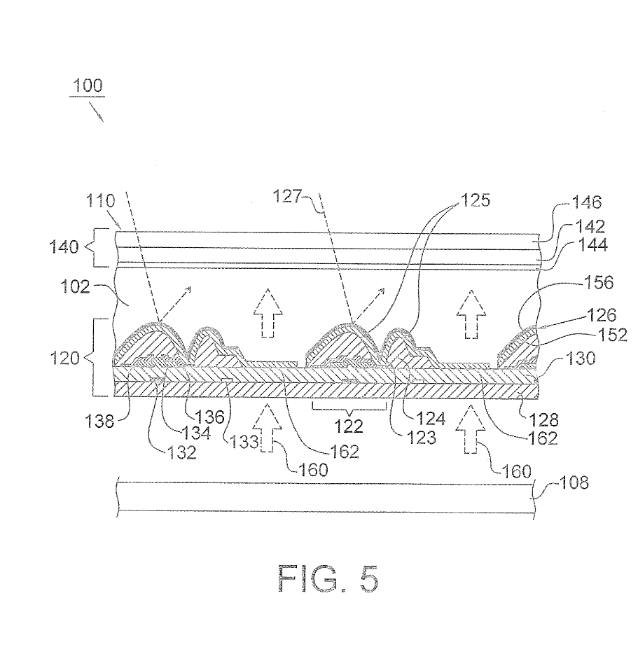

Otherwise, referring to FIG. 5, it depicts a liquid crystal display device 100 according to another alternative embodiment of the present invention. The pixel electrode 126 can include a transparent electrode 152 and a reflective film 156. In other words, the transparent electrode 152 can be used to conduct electricity and transmit the light, can be disposed on the concave-convex surface 125 and the light-transmissive region 162, and can be electrically connected to the thin film transistor 122 via the contact hole 123. The reflective film 156 can be used to reflect the light and can be disposed on the transparent electrode 152, and can expose out the transparent electrode 152, which is located on the light-transmissive region 162. The transparent electrode 152 can be made of indium tin oxide (ITO).

Referring to FIG. 3 again, the upper substrate 140 includes an opposing transparent electrode 144 disposed over another transparent substrate 146. In this embodiment, a color filter layer 142 can be disposed between the transparent electrode 144 and the transparent substrate 146. Otherwise, in another alternative embodiment, a color filter layer (not shown) can be disposed between the pixel electrode 126 and the gate insulating film 130, i.e. the color filter layer is designed by using a color filter on array (COA) technology. Otherwise, in another alternative embodiment, a color filter layer (not shown) can be disposed between the transparent substrate 146 and the thin film transistor 122, i.e. the thin film transistor 122 is formed by using an array on color filter (AOC) technology. The transparent substrate 146 generally includes a polarizing film (not shown) and a retardation film (not shown).

Furthermore, the thin film transistor 122 of the present invention further includes a low electrode 133 of storage capacitor, wherein the gate insulating film 130 and the passivation insulating layer 124 are located between the low electrode 133 of storage capacitor and the pixel electrode 126 so as to define a dielectric layer of storage capacitor. In other words, the dielectric layer of storage capacitor includes the gate insulating film 130 and the passivation insulating layer 124, and the pixel electrode 126, which is located upon the low electrode 133 of storage capacitor, is defined a top electrode of storage capacitor. The passivation insulating layer 124 of the present invention which is located between the low electrode 133 of storage capacitor and the pixel electrode 126 has a predetermined thickness by simultaneously using the same gray-scale photomask and photolithography process. In other words, the dielectric layer of storage capacitor has a predetermined thickness, thereby determining the capacitance of storage capacitor. Thus, determining the capacitance of the storage capacitor of the present invention can be completed without additional photolithography process. Only the same original gray-scale photomask and photolithography process is required.

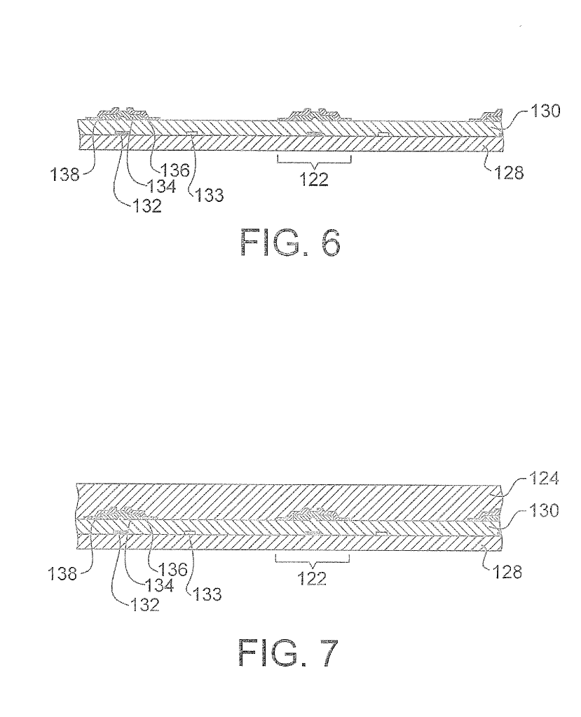

A method for manufacturing the liquid crystal display device in this embodiment includes the following steps. Referring to FIG. 6, a transparent substrate 128 is provided first. A plurality of gate electrode 132 and a plurality of low electrodes 133 of storage capacitor are formed on the transparent substrate 128 by using a common photomask and a photolithography process. A gate insulating film 130 is formed on the transparent substrate 128 and covers the gate electrodes 132 and the low electrodes 133 of storage capacitor. A plurality of semiconductor layers 134, a plurality of source electrodes 138 and a plurality of drain electrodes 136 are formed on the gate insulating films 130 so as to form a plurality of thin film transistors 122.

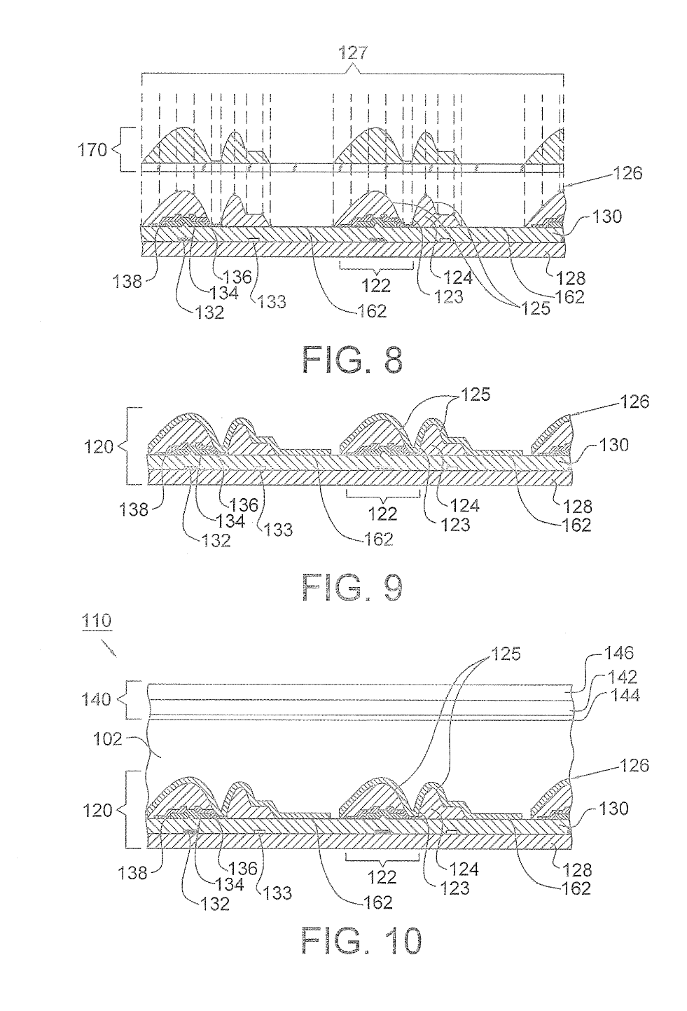

Referring to FIG. 7, a passivation insulating layer 124 is covered on the gate insulating film 130 and the thin film transistors 122. Referring to FIG. 8, the passivation insulating layer 124 is patterned to have the structure of a concave-convex surface 125 and a plurality of contact holes 123 by using a gray-scale photomask 170 and a photolithography process. Through the same gray-scale photomask 170 and photolithography process, the passivation insulating layer 124 is simultaneously patterned to further have a plurality of light-transmissive regions 162 (which is directly disposed on the gate insulating film 130) and a predetermined thickness which is located above the low electrodes 133 of storage capacitor. For example, the passivation insulating layer 124 can be made of an organic or an inorganic material, which can be covered a photo-resist (not show) and then irradiated by a proper light 127, e.g. an ultraviolet. The light 127, which is from the outside of the gray-scale photomask 170, irradiates the photo-resist for exposing the photo-resist. The photo-resist, a negative type, is cross-linking after irradiating the light 127. In other words, after the light 127 irradiates the photo-resist, the photo-resist is hardened to prevent from being dissolved in a developer. After being developed, etched and stripped, the passivation insulating layer 124 is formed with a concave-convex surface 125, a contact hole 123 and a light-transmissive region 162. The gray-scale photomask 170 can be a slit mask, e.g. the gray-scale photomask 170 can be formed by an optical grating or a partly light-transmissive region so as to control the transmissive amount of the light 127, thereby defining the required thickness of the passivation insulating layer 124 at any region.

Referring to FIG. 9, a plurality of pixel electrode 126 are formed on the concave-convex surface 125 and the light-transmissive regions 162 by a common photomask and a photolithography process, thereby forming a plurality of pixel regions of a thin film transistor substrate 120, wherein each pixel electrode 126 is electrically connected to the thin film transistor 122 via the contact hole 123. The pixel electrode 126, which is located on the concave-convex surface 125 of the passivation insulating layer 124, is in the shape of similar concave-convex surface. It is apparent to those skilled in the art that the pixel electrode 126 can be made of transflective material. Otherwise, the pixel electrode 126 can include a transparent electrode 152 and a transflective film 154, shown in FIG. 4. Otherwise, the pixel electrode 126 can include a transparent electrode 152 and a reflective film 156, shown in FIG. 5.

Referring to FIG. 10, a liquid crystal layer 102 is disposed between the thin film transistor substrate 120 and an upper substrate 140 so as to form a liquid crystal display panel 110. In this embodiment, the upper substrate 140 includes a color filter layer 142 and a transparent electrode 144 which are disposed on another transparent substrate 146 in sequence. Otherwise, in another alternative embodiment, a color filter layer (not shown) can be formed on the pixel electrode 126 of the thin film transistor substrate 120.

Then, a backlight source 108 is disposed under the liquid crystal display panel 110 so as to form a liquid crystal display device 100, shown in FIG. 3.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A thin film transistor substrate comprising:
a transparent substrate;
a plurality of thin film transistors disposed on the transparent substrate and comprising a gate insulating film;
a passivation insulating layer disposed on the gate insulating film and covering the thin film transistors, wherein the passivation insulating layer is formed with a concave-convex surface, a plurality of contact holes and a plurality of light-transmissive regions, and the light-transmissive regions are located above the gate insulating film; and
a plurality of pixel electrodes disposed on the concave-convex surface and the light-transmissive regions, wherein each pixel electrode is electrically connected to the thin film transistor via the contact hole.

2. The thin film transistor substrate as claimed in claim 1, wherein the passivation insulating layer is formed with the concave-convex surface, the contact holes and the light-transmissive regions by a gray-scale photomask and a photolithography process.

3. The thin film transistor substrate as claimed in claim 1, wherein the passivation insulating layer is made of one of organic material and inorganic material.

4. The thin film transistor substrate as claimed in claim 1, wherein the pixel electrode is made of electrically conductive and transflective material.

5. The thin film transistor substrate as claimed in claim 1, wherein the pixel electrode comprises a transparent electrode and a transflective film.

6. The thin film transistor substrate as claimed in claim 5, wherein:
the transparent electrode is disposed on the concave-convex surface and the light-transmissive region, and is electrically connected to the thin film transistor via the contact hole; and
the transflective film is disposed on the transparent electrode.

7. The thin film transistor substrate as claimed in claim 1, wherein the pixel electrode comprises a transparent electrode and a reflective film.

8. The thin film transistor substrate as claimed in claim 7, wherein:
the transparent electrode is disposed on the concave-convex surface and the light-transmissive region, and is electrically connected to the thin film transistor via the contact hole; and
the reflective film is disposed on the transparent electrode and exposes out the transparent electrode which is located on the light-transmissive region.

9. The thin film transistor substrate as claimed in claim 2, wherein the gray-scale photomask is a slit mask.

10. The thin film transistor substrate as claimed in claim 2, wherein:
the thin film transistors further comprise a plurality of low electrodes of storage capacitor; and
the gate insulating film and the passivation insulating layer are located between the low electrodes of storage capacitor and the pixel electrode so as to define a dielectric layer of storage capacitor.

11. The thin film transistor substrate as claimed in claim 10, wherein the dielectric layer of storage capacitor which is located between the low electrode of storage capacitor and the pixel electrode has a predetermined thickness by using the same gray-scale photomask and photolithography process.

12. A method for manufacturing a thin film transistor substrate comprising the steps of:
providing a transparent substrate;
forming a plurality of thin film transistors on the transparent substrate, wherein the thin film transistors comprise a gate insulating film and a plurality of low electrodes of storage capacitor, wherein the low electrodes of storage capacitor and the gate insulating film are formed on the transparent substrate in sequence;
disposing a passivation insulating layer on the thin film transistors;
patterning the passivation insulating layer to form with a concave-convex surface and a plurality of contact holes and a plurality of light-transmissive regions, wherein the light-transmissive regions are located on the gate insulating film; and
forming a plurality of pixel electrodes on the concave-convex surface and the light-transmissive regions so as to form a plurality of pixel regions of a thin film transistor substrate, wherein each pixel electrode is electrically connected to the thin film transistor via the contact hole.

13. The method as claimed in claim 12, wherein the passivation insulating layer is patterned to form with the concave-convex surface, the contact holes and the light-transmissive regions by a gray-scale photomask and a photolithography process.

14. The method as claimed in claim 13, further comprising the steps of:
forming a dielectric layer of storage capacitor which is located above the low electrode of storage capacitor to have a predetermined thickness by using the same gray-scale photomask and photolithography process, wherein the gate insulating film and the passivation insulating layer are located between the low electrode of storage capacitor and the pixel electrode so as to define the dielectric layer of storage capacitor.

15. A method for manufacturing a liquid crystal display panel comprising the steps of:
providing a transparent substrate;
forming a plurality of thin film transistors on the transparent substrate, wherein the thin film transistors comprise a gate insulating film and a plurality of low electrodes of storage capacitor, wherein the low electrodes of storage capacitor and the gate insulating film are formed on the transparent substrate in sequence;
disposing a passivation insulating layer on the thin film transistors;
patterning the passivation insulating layer to form with a concave-convex surface and a plurality of contact holes and a plurality of light-transmissive regions, wherein the light-transmissive regions are located on the gate insulating film; and
forming a plurality of pixel electrodes on the concave-convex surface and the light-transmissive regions so as to form a plurality of pixel regions of a thin film transistor substrate, wherein each pixel electrode is electrically connected to the thin film transistor via the contact hole; and
disposing a liquid crystal layer between the thin film transistor substrate and an upper substrate.

16. The method as claimed in claim 15, wherein the passivation insulating layer is patterned to form with the concave-convex surface, the contact holes and the light-transmissive regions by a gray-scale photomask and a photolithography process.
